(19) United States
(12) Patent Application Publication
(10) Pub. No.: US 2019/0010072 A1
(43) Pub. Date: Jan. 10, 2019

(54) METHOD AND APPARATUS FOR CONTINUOUS PROCESSING OF A FLEXIBLE GLASS RIBBON

(71) Applicant: CORNING INCORPORATED, CORNING, NY (US)

(72) Inventors: Tomohiro Aburada, Painted Post, NY (US); Gautam Narendra Kudva, Horseheads, NY (US)

(73) Assignee: CORNING INCORPORATED, CORNING, NY (US)

(21) Appl. No.: 16/068,389

(22) PCT Filed: Jan. 6, 2017
(86) PCT No.: PCT/US17/12438

§ 371 Date: Jul. 6, 2018

Related U.S. Application Data
(60) Provisional application No. 62/275,981, filed on Jan. 7, 2016.

(51) Int. Cl. C03B 17/06; C03B 33/023; C03B 33/02

(52) U.S. Cl. CPC C03B 17/068; C03B 33/0222; C03B 33/0235

(57) ABSTRACT

Disclosed herein are methods for continuous processing of a thin, flexible glass ribbon through various processing zones and maintaining a concave or substantially linear machine directional (MD) and/or cross-directional (CD) curvature of the flexible glass ribbon through at least two or more contiguous zones in the process. Apparatuses for the continuous processing of a thin, flexible glass ribbon while maintaining a desired MD and/or CD curvature are also disclosed herein.

### CROSS-REFERENCE TO RELATED APPLICATIONS

This application claims the benefit of priority under 35 U.S.C. § 119 of U.S. Provisional Application Ser. No. 62/275,981 filed on Jan. 7, 2016, the content of which is relied upon and incorporated herein by reference in its entirety.

### FIELD OF THE DISCLOSURE

The disclosure relates to an apparatus and method for continuous processing of a flexible glass ribbon and, in particular, to methods for continuous processing of a flexible glass ribbon while maintaining a concave or substantially planar curvature of the flexible glass ribbon in the machine direction through at least a portion of the process.

### BACKGROUND

Glass processing apparatuses are commonly used to form various glass products such as sheet glass for electronics, e.g., LCDs and the like. Glass substrates in flexible electronic applications are becoming thinner and lighter. Glass substrates having thicknesses lower than 0.5 mm, for example less than 0.35 mm, for example 0.1 mm or even thinner can be desirable for certain display applications, for instance, portable electronic devices such as laptop computers, handheld devices, and the like.

Flexible glass substrates, for example, glass substrates used in the manufacture of display devices, are often processed in sheet form. Such processing can include, for example, the deposition of thin film electronics onto the substrate. Sheet form handling has relatively slow processing speeds compared to continuous processes, since sheets must be individually transported, fixtured, processed and removed. Continuous processing of flexible glass substrates in ribbon form can provide relatively faster manufacturing rates. One additional benefit for a thin glass substrate is that the flexibility afforded by the thin ribbon allows it to be used in processes utilizing rolls of the material.

During continuous processing, the machine directional (MD) curvature of the glass ribbon can change several times including, for example, flipping from concave to convex orientations one or more times along the process line. The glass forming process may also impart cross-directional (CD) curvature to the ribbon, e.g., due to an imprinted shape in the glass forming process and/or sag. CD and MD curvatures of the glass ribbon can be perpendicular to one another and one or both can flip at various transitions between stages in the continuous process. However, without a physical constraint in the pivot at these transition points, the CD and/or MD curvature flip may be unstable, which can result in sheet vibration. Sheet vibrations can impart instability to the process and may negatively impact various downstream steps in the process, e.g., laser cutting of the ribbon. Other complications resulting from CD and/or MD curvature flips can include stubbing, fracture, crack out, and/or other process disruptions. In addition, changes in the glass ribbon shape can also change the energy state of the ribbon, which can impact processing capabilities (e.g., quality, process window, etc.).

Accordingly, it would be advantageous to provide improved methods and apparatuses for continuously processing a glass ribbon that minimizes or eliminates changes in radius of curvature of the ribbon, e.g., from positive (concave) to negative (convex), in the machine direction. It would also be advantageous to provide methods and apparatuses which can maintain a concave or substantially linear MD curvature of the ribbon between one or more stages of the process.

### SUMMARY

The disclosure relates, in various embodiments, to methods for continuous processing of a flexible glass ribbon having a thickness of no more than 0.5 mm, the methods comprising continuously feeding the flexible glass ribbon from a first processing zone, through a second processing zone and to a third processing zone of a glass processing apparatus; supporting the flexible glass ribbon in a first catenary between a first pair of spaced-apart payoff positions in a first buffer zone located between the first processing zone and the second processing zone; supporting the flexible glass ribbon in a second catenary between a second pair of spaced-apart payoff positions in a second buffer zone located between the second processing zone and the third processing zone; and maintaining a positive machine directional (MD) radius of curvature of the flexible glass ribbon during transition from at least one of (a) the first buffer zone to the second processing zone or (b) the second processing zone to the second buffer zone.

Also disclosed herein are methods for continuous processing of a flexible glass ribbon having a thickness of no more than 0.5 mm using a glass processing apparatus including a forming apparatus in a first processing zone, an edge trimming apparatus in a second processing zone, and a winding apparatus in a third processing zone, the methods comprising forming the flexible glass ribbon in the first processing zone and feeding the flexible glass ribbon though the first processing zone; feeding the flexible glass ribbon through the second processing zone while separating a continuous strip of edge trim from a central portion of the flexible glass ribbon; feeding the flexible glass ribbon through the third processing zone while winding the flexible glass ribbon into a roll; wherein a positive MD radius of curvature of the flexible glass ribbon is maintained within a first buffer zone between the first and second processing zones and within a second buffer zone between the second and third processing zones; and wherein an infinite MD radius of curvature of the flexible glass ribbon is maintained within the second processing zone.

Further disclosed herein are apparatuses for processing a flexible glass ribbon having a thickness of no more than 0.5 mm, the apparatuses comprising a forming apparatus in a first processing zone, the forming apparatus configured to form a flexible glass ribbon; an edge trimming apparatus in a second processing zone, the edge trimming apparatus configured to separate a continuous strip of edge trim from a central portion of the flexible glass ribbon; a winding apparatus in a third processing zone, the winding apparatus configured to wind the flexible glass ribbon into a roll; a first buffer zone located between the first processing zone and the second processing zone in which the flexible glass ribbon is supported in a first catenary between a first upstream payoff position and a first downstream payoff position; and a second buffer zone located between the second processing zone and the third processing zone in which the flexible glass substrate is supported in a second catenary between a second upstream payoff position and a second downstream payoff position, wherein the first downstream payoff position is elevated relative to an edge trimming position in the second processing zone, the edge trimming position is elevated relative to a second processing zone outlet, and the second downstream payoff position is elevated relative to the second processing zone outlet. For example, the first processing zone, first buffer zone, second processing zone, and second buffer zone may be positioned relative to each other such that a positive or infinite MD radius of curvature of the flexible glass ribbon is maintained during transition from at least one of (a) the first buffer zone to the second processing zone or (b) the second processing zone to the second buffer zone.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings.

FIG. 1 is a schematic view of an embodiment of a flexible glass forming method and apparatus;

FIG. 2 is a schematic detail view of the flexible glass forming method and apparatus of FIG. 1;

FIG. 3 is a schematic plan view of an embodiment of an edge trimming method and apparatus;

FIG. 4 is a schematic side view of the edge trimming method and apparatus of FIG. 3;

FIG. 5 is a schematic plan view of an embodiment of a glass processing apparatus over one half of a width of the flexible glass ribbon that can include the flexible glass forming apparatus of FIG. 1, the edge trimming apparatus of FIG. 3, and a glass winding apparatus;

FIG. 6 illustrates an embodiment of a glass winding apparatus for use in the glass processing apparatus of FIG. 5;

FIG. 7 is a schematic of the web path for a continuous processing method, CD curvature, and MD radius of curvature of the ribbon at various stages in the method;

FIG. 8 is a schematic of a web path for continuous processing methods and apparatuses according to embodiments of the disclosure;

FIG. 9 is a magnified portion of the web path schematic of FIG. 8;

FIG. 10 is a schematic of a web path for continuous processing methods and apparatuses according to certain embodiments of the disclosure; and

FIG. 11 is a schematic of a web path for continuous processing methods and apparatuses according to additional embodiments of the disclosure.

### DETAILED DESCRIPTION

Embodiments described herein generally relate to apparatuses and methods for continuous manufacturing of flexible glass ribbon by minimizing MD and/or CD curvature changes (e.g., flips from convex to concave) of the continuous flexible glass ribbon at locations throughout the process from root to spooler or winder. A number of processing and buffer zones may be provided within the process where shape of the continuous flexible glass ribbon can be controlled by positioning such zones relative to one another to minimize MD and/or CD curvature changes for the flexible glass ribbon. In some embodiments, the methods can comprise maintaining a concave or substantially linear MD and/or CD curvature of the flexible glass ribbon through at least two or more contiguous zones in the process.

While glass is generally known as a brittle material, inflexible and prone to scratching, chipping, and fracture, glass having a thin cross section can, in fact, be quite flexible. Glass in long thin sheets or ribbons can be wound and un-wound from rolls, much like paper or plastic film.

Some glass ribbons are processed by continuously separating thickened edge beads from the glass ribbon. During the edge trimming process, the thickened edge beads can be separated from the glass ribbon and conveyed down a path different than that of a central (or quality) portion of the glass ribbon. Before and/or after bead removal, the glass ribbon may pass through one or more buffer zones in which the ribbon is allowed to hang in free loops (which may also be called catenaries). The transition into and/or out of the edge processing zone can result in one or more flips in the MD and/or CD curvature of the ribbon from concave (free loop) to convex (bead removal).

The apparatuses and methods described herein may facilitate continuous processing of flexible glass ribbon by minimizing changes in MD and/or CD curvature along the web processing path, e.g., from the forming process step to the winding process step. The processing zones may include forming, edge separation, and winding zones; however, other types of processing zones may also be utilized. Such apparatuses and methods can be used to continuously process the flexible glass ribbon while reducing or eliminating potential process disturbances resulting from flips in MD and/or CD curvature.

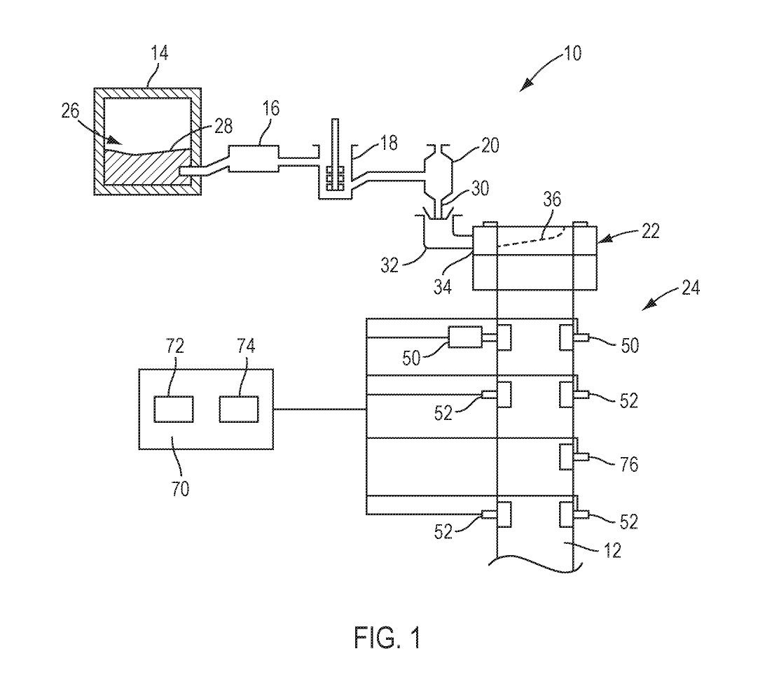

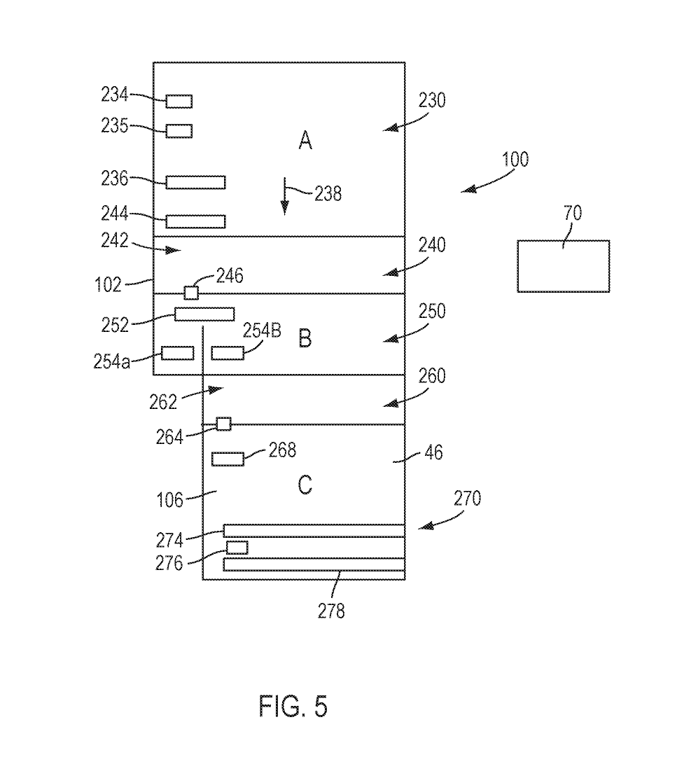

Referring to FIG. 1, an exemplary glass manufacturing apparatus 10 incorporating a fusion process to produce a glass ribbon 12 is depicted. The glass manufacturing apparatus 10 may be part of a glass processing apparatus 100 (FIG. 5), as will be described in greater detail below, where a glass ribbon is formed, separated along edges and then rolled in a continuous process. The glass manufacturing apparatus 10 can include a melting vessel 14, a fining vessel 16, a mixing vessel 18 (e.g., a stir chamber), a delivery vessel 20 (e.g., a bowl), a forming apparatus 22, and a draw apparatus 24. The glass manufacturing apparatus 10 can produce a continuous glass ribbon 12 from batch materials, first by melting and combining the batch materials into molten glass, distributing the molten glass into a preliminary shape, applying tension to the glass ribbon 12 to control the dimensions of the glass ribbon 12 as the glass cools and viscosity increases such that the glass ribbon 12 goes through a visco-elastic transition and has mechanical properties that that give the glass ribbon 12 stable dimensional characteristics.

In operation, batch materials for forming glass may be introduced into the melting vessel 14 as indicated by arrow 26 and melted to form molten glass 28. The molten glass 28 can flow into the fining vessel 16, wherein gas bubbles can be removed from the molten glass. From the fining vessel 16, the molten glass 28 can flow into the mixing vessel 18, where the molten glass 28 can undergo a mixing process to homogenize the molten glass 28. The molten glass 28 can then flow from the mixing vessel 18 to the delivery vessel 20, which can deliver the molten glass 28 through a downcomer 30 to an inlet 32 and into the forming apparatus 22.

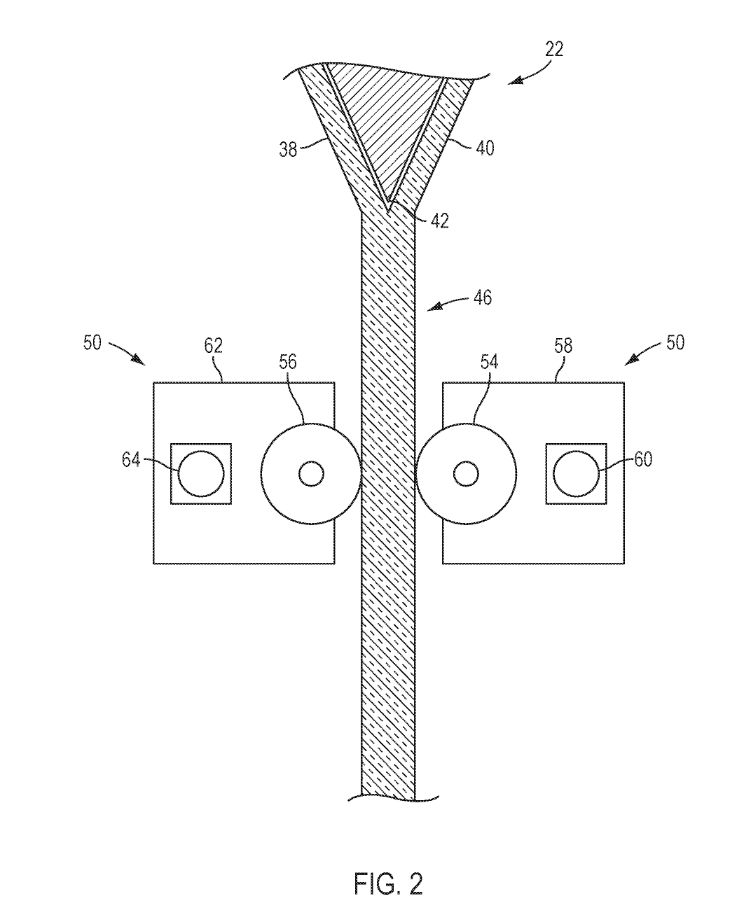

The forming apparatus 22 depicted in FIG. 1 can be used in a fusion draw process to produce a flexible glass ribbon 46 that has high surface quality and low variation in thickness. The forming apparatus 22 can include an opening 34 that receives the molten glass 28. The molten glass 28 can flow into a trough 36 and can then overflow and run down the sides of the trough 36 in two partial ribbon portions 38, 40 (see FIG. 2) before fusing together below the root 42 of the forming apparatus 22. The two partial ribbon portions 38, 40 of the still molten glass 28 can rejoin with one another (e.g., fuse) at locations below the root 42 of the forming apparatus 22, thereby forming a flexible glass ribbon 46 (also referred to as a glass ribbon). The flexible glass ribbon 46 can be drawn downward from the forming apparatus by the draw apparatus 24. While the forming apparatus 22 is shown and described herein implements a fusion draw machine (FDM), it should be understood that other forming apparatuses may be used including, without limitation, slot draw apparatuses for example.

As shown in FIGS. 1-2, and as will be described in greater detail below, the draw apparatus 24 may, in various embodiments, include a plurality of actively-driven stub roller pairs 50, 52, each of which can include a front-side stub roller 54 and a rear-side stub roller 56. The front-side stub roller 54 can be coupled to a front-side transmission 58, which can be coupled to a front-side motor 60. The front-side transmission 58 can modify the output speed and torque of the front-side motor 60 that is delivered to the front-side stub roller 54. Similarly, the rear-side stub roller 56 can be coupled to a rear-side transmission 62, which can be coupled to a rear-side motor 64. The rear-side transmission 62 can modify the output speed and torque of the rear-side motor 64 that is delivered to the rear-side stub roller 56.

In some embodiments, operation of the plurality of stub roller pairs 50, 52 may be controlled by a global control device 70 (e.g., a programmable logic controller—PLC) for a variety of conditions including, for example and without limitation, torque applied to the flexible glass ribbon 46 and rate of rotation of the stub rollers 54, 56. The draw forces applied to the flexible glass ribbon 46 by the plurality of stub roller pairs 50, 52 while the flexible glass ribbon 46 is still in a viscoelastic state can cause the flexible glass ribbon 46 to pull or stretch, thereby controlling the dimensions of the flexible glass ribbon 46 by controlling the tension applied to the flexible glass ribbon 46 in one or both the draw and cross-draw directions as the flexible glass ribbon 46 translates along the draw apparatus 24, while also imparting motion to the flexible glass ribbon 46. The global control device 70 may, in various embodiments, use the draw apparatus 24 to set a global master speed for the glass processing apparatus 100 (FIG. 5), while also shaping the flexible glass ribbon 46.

The global control device 70, if present, may include computer readable instructions stored in memory 72 and executed by a processor 74 that can determine, among other things, draw tension and speed of the flexible glass ribbon 46 provided by the stub roller pairs 50 and 52, for example, using any suitable sensors that provide feedback to the global control device 70. Further, the computer readable instructions can allow modification of parameters, for example torque and velocity of the stub roller pairs 50, 52 in light of feedback from the sensors. As one example, a stub roller 76 may be provided that communicates with the global control device 70 to indicate rate of rotation. The rate of rotation of the stub roller 76 with the flexible glass ribbon 46 can be used by the global control device 70 to determine the extrinsic linear feed rate of the flexible glass ribbon 46 as the flexible glass ribbon 46 moves thereby. Although there is shown one pair of stub rollers 50 on each side of the ribbon, any suitable number of these types of stub roller pairs may be used, depending upon draw length and desired control. Similarly, although two of stub roller pairs 52 are shown on each side of the ribbon, any suitable number of these types of stub roller pairs 52 may be used.

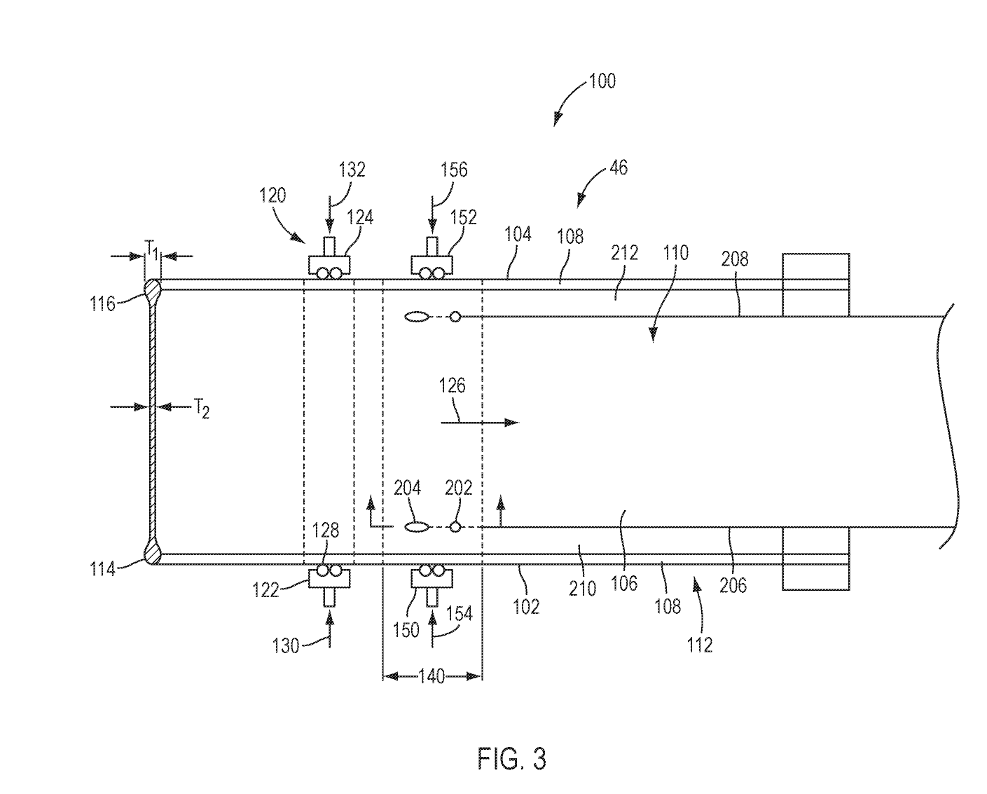

Referring to FIG. 3, as noted above, the glass manufacturing system 10 may be part of a glass processing apparatus 100. The flexible glass ribbon 46 is illustrated as being conveyed through the glass processing apparatus 100, another portion of which is illustrated by FIG. 3. The flexible glass ribbon 46 may be conveyed in a continuous fashion from the glass manufacturing system 10 (FIG. 1) through the glass processing apparatus 100. The flexible glass ribbon 46 can include a pair of opposed first and second edges 102 and 104 that can extend along a length of the flexible glass ribbon 46 and a central portion 106 that spans between the first and second edges 102 and 104. In some embodiments, the first and second edges 102 and 104 may be covered in a pressure sensitive adhesive tape 108 that is used to protect and shield the first and second edges 102 and 104 from contact. The tape 108 may be applied to one or both of the first and second edges 102 and 104 as the flexible glass ribbon 46 moves through the apparatus 100. In other embodiments, the adhesive tape 108 may not be used. A first major surface 110 and an opposite, second major surface 112 can also span between the first and second edges 102 and 104, forming part of the central portion 106.

In embodiments where the flexible glass ribbon 46 is formed using a down draw fusion process, the first and second edges 102 and 104 may include beads 114 and 116 with a thickness T1 that is greater than a thickness T2 within the central portion 106. The central portion 106 may be “ultra-thin” having a thickness T2 of about 0.5 mm or less including but not limited to thicknesses of, for example, about 0.01-0.05 mm, about 0.05-0.1 mm, about 0.1-0.15 mm and about 0.15-0.3 mm, although flexible glass ribbons 46 with other thicknesses may be formed in other examples.

The flexible glass ribbon 46 can be conveyed through the apparatus 100 using a conveyor system 120 that can be controlled by the optional global control device 70. Lateral guides 122 and 124 may be provided to orient the flexible glass ribbon 46 in the correct lateral position relative to the machine or travel direction 126 of the flexible glass ribbon 46. For example, as schematically shown, the lateral guides 122 and 124 may include rollers 128 that engage the first and second edges 102 and 104. Opposing forces 130 and 132 may be applied to the first and second edges 102 and 104 using the lateral guides 122 and 124 that can help to shift and align the flexible glass ribbon 46 in the desired lateral orientation in the machine direction 126.

The glass processing apparatus 100 can further include a cutting zone 140 which may include, for example, an edge trimming apparatus configured to separate the first and second edges 102 and 104 from the central portion 106 of the flexible glass ribbon 46 in a continuous fashion. Optional lateral guides 150 and 152 may be provided to orient the flexible glass ribbon 46 in the correct lateral position relative to the machine direction 126 of the flexible glass ribbon 46. Opposing forces 154 and 156 may be applied to the first and second edges 102 and 104 using the optional lateral guides 150 and 152 that can help to shift and align the flexible glass ribbon 46 in the desired lateral orientation in the machine direction 126.

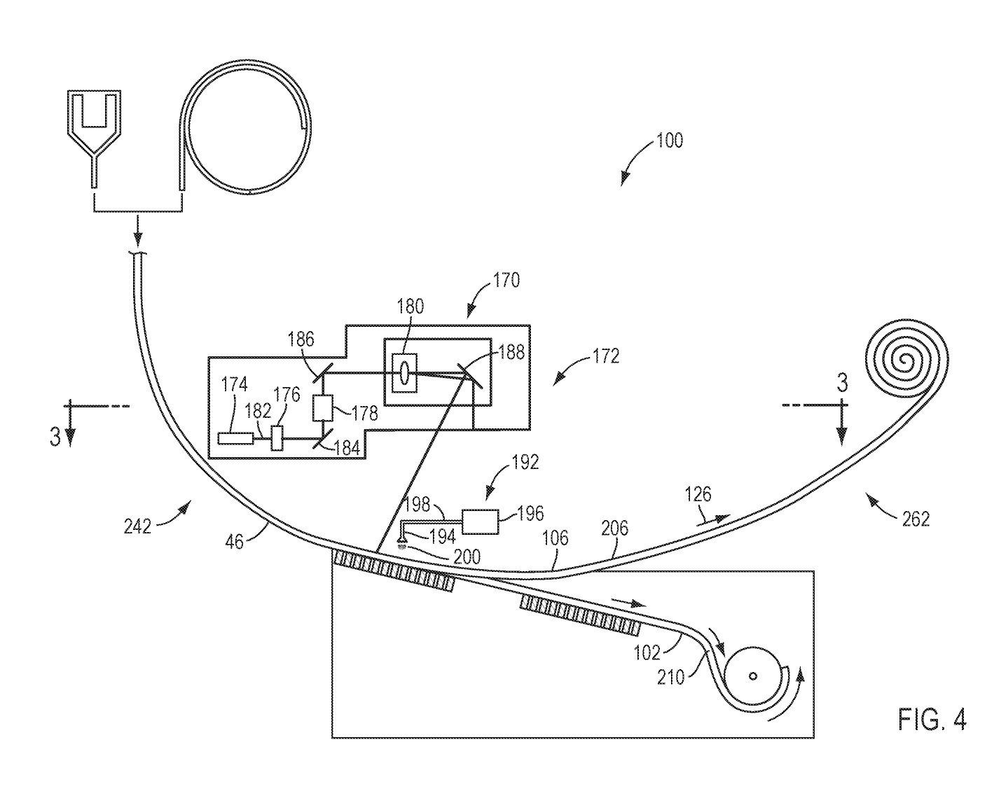

In one embodiment, as shown in FIG. 4, an exemplary edge trimming apparatus 170 can include an optical delivery apparatus 172 for irradiating and therefore heating a portion of the upwardly facing surface of the flexible glass ribbon 46. In one example, optical delivery apparatus 172 can comprise a cutting device for example the illustrated laser 174 although other radiation sources may be provided in further examples. The optical delivery apparatus 172 can further include a circular polarizer 176, a beam expander 178, and a beam shaping apparatus 180.

The optical delivery apparatus 172 may further comprise optical elements for redirecting a beam of radiation (e.g., laser beam 182) from the radiation source (e.g., laser 174), for example mirrors 184, 186 and 188. The radiation source can comprise the illustrated laser 174 configured to emit a laser beam having a wavelength and a power suitable for heating the flexible glass ribbon 46 at a location where the beam is incident on the flexible glass ribbon 46. In one embodiment, laser 174 can comprise a CO₂ laser although other laser types may be used in further examples.

As further shown in FIG. 4, the example edge trimming apparatus 170 can also include a coolant fluid delivery apparatus 192 configured to cool the heated portion of the upwardly facing surface of the flexible glass ribbon 46. The coolant fluid delivery apparatus 192 can comprise a coolant nozzle 194, a coolant source 196 and an associated conduit 198 that may convey coolant to the coolant nozzle 194. In one example, a coolant jet 200 comprises water, but may be any suitable cooling fluid (e.g., liquid jet, gas jet or a combination thereof) that does not stain or damage the upwardly facing surface of the flexible glass ribbon 46. The coolant jet 200 can be delivered to a surface of the flexible glass ribbon 46 to form a cooling zone 202. As shown, the cooling zone 202 can trail behind a radiation zone 204 to propagate an initial crack (FIG. 3).

The combination of heating and cooling with the optical delivery apparatus 172 and the coolant fluid delivery apparatus 192 can effectively separate the first and second edges 102 and 104 from the central portion 106 while minimizing or eliminating undesired residual stress, microcracks or other irregularities in the opposed edges 206, 208 of the central portion 106 that may be formed by other separating techniques. Moreover, the continuous strips of edge trim 210 and 212 can be removed from the central portion 106. The central portion 106 may then be wound into a roll using a winding apparatus 270.

FIG. 5 is a schematic view of one half of a glass ribbon, whereupon it will be appreciated that a similar arrangement will exist on the right half of this figure but, in the interest of simplifying the discussion, is not shown. The glass processing apparatus may be divided into a number of processing zones, each zone corresponding to one or more different processes. In the illustrated example shown schematically, processing zone A includes a flexible glass ribbon forming process, processing zone B includes a flexible glass ribbon cutting process and processing zone C includes a flexible glass ribbon winding process, where the processes within the processing zones may be similar to any of the processes described above.

Processing zone A may include a forming apparatus 230, similar to or the same as the forming apparatus 22 described above with reference to FIG. 1, where a fusion draw process is used to produce the flexible glass ribbon 46. Driven rollers (e.g., multiple elevations of driven roller pairs) represented by elements 234, 235, and 236 may optionally be used to apply adjustable mechanical tensions in the machine direction 238. In some non-limiting embodiments, one or more of the driven rollers 234, 235, and 236 (e.g., driven roller 235) may also be used by a global control device 70 to set a global master speed within at least processing zone A.

A buffer zone 240 can be provided between processing zone A and processing zone B, in which the flexible glass ribbon 46 may be held in a free loop 242 (FIG. 4) and may hang in a catenary between two pay off positions, e.g., defined by driven rollers 244 and 246 (more particularly, the location where the flexible glass ribbon 46 releases from the driven rollers 244 and 246). For example, rollers 244 and 246 may be from 4 meters to 12 meters apart, for example, from about 1.5 meters to about 7.5 meters apart, to allow use of a number of cullet chutes, loop sensing and/or mitigation devices, etc. Between these two pay off positions the flexible glass ribbon 46 may not be pulled tight and can be allowed to hang under its own weight.

The free loop 242 shape can self-adjust depending on the amount of pull force and gravitational force within the buffer zone 240. The free loop 242 can accommodate more or less flexible glass ribbon 46 by adjusting the free loop 242 shape, which can be controlled by tension within the free loop 242. The buffer zone 240 can, in some embodiments, serve as an accumulator of error between processing zones A and B. The buffer zone 240 can accommodate errors, for example, path length differences due to velocity, twist or shape variance due to strain mismatch and machine misalignment errors. In some embodiments, a loop sensor, for example an ultrasonic or optical sensor, may be provided to maintain a preselected loop height.

Processing zone B may include an edge trimming apparatus 250, similar to or the same as the edge trimming apparatus 170 described above with reference to FIGS. 3-4, where first and second edges (only edge 102 is shown in FIG. 5) are separated from central portion 106 of the flexible glass ribbon 46. Driven rollers represented by elements 252, 254a, and 254b may optionally be used to apply adjustable mechanical tensions in the machine direction 238 and/or to control steering of the flexible glass ribbon 46 and first and second edges (only edge 102 is shown) as they are separated from the central portion 106. Roller 246 may be driven during initial threading of the flexible glass ribbon 46, but may thereafter be idle for cross-direction steering or guiding of the flexible glass ribbon 46 within the processing zone B. In some embodiments, the driven rollers 252, 254a and 254b may be used by an optional global control device 70 to set a local master speed within the processing zone B. It should be noted that variance between the global and local master speeds within the zones A, B and C, if any, can be provided to allow for tension management within the flexible glass ribbon 46, as well as absolute error management.

Another buffer zone 260 can be provided between processing zone B and processing zone C, in which the flexible glass ribbon 46 may be held in a free loop 262 (FIG. 4) and may hang in a catenary between two pay off positions, e.g., defined by driven rollers 254b and 264). For example, rollers 254b and 264 may be from about 4 meters to about 12 meters apart, for example, from about 1.5 meters to about 7.5 meters apart, to allow use of a number of cullet chutes, loop out mitigation devices, etc. Between these two pay off positions the flexible glass ribbon 46 may not be pulled tight and can be allowed to hang under its own weight.

The free loop 262 shape can self-adjust depending on the amount of pull force and gravitational force within the buffer zone 260. The free loop 262 can accommodate more or less flexible glass ribbon 46 by adjusting the free loop 262 shape, which can be controlled by tension within the free loop 262. The buffer zone 260 can, in some embodiments, serve as an accumulator of error between processing zones B and C. The buffer zone 260 can accommodate errors for example path length differences due to velocity, twist or shape variance due to strain mismatch and machine misalignment errors. In some embodiments, a loop sensor, for example an ultrasonic or optical sensor, may be provided to maintain a preselected loop height.

Processing zone C may include a winding apparatus 270, where the central portion 106 of the flexible glass ribbon 46 is wound into a roll. Driven rollers represented by elements 268, 274, 276 and 278 may optionally be used to apply adjustable mechanical tensions in the machine direction 238 and/or to control steering of the flexible glass ribbon 46. Roller 264 may be driven during initial threading of the flexible glass ribbon 46, but may thereafter be idle for cross-direction steering or guiding of the flexible glass ribbon 46 within the processing zone C. In one non-limiting embodiment, one or more of the driven rollers 268, 274, 276, and 278 (e.g., driven rollers 274 and 278) may be used to by an optional global control device 70 to set a local master speed within the processing zone C.

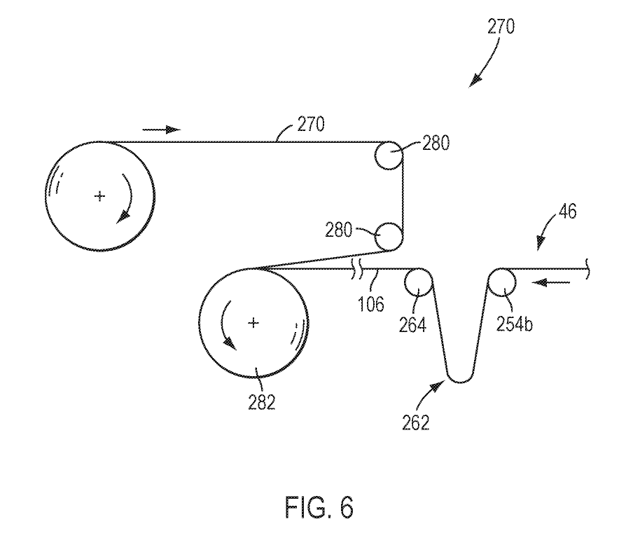

FIG. 6 illustrates schematically an exemplary winding apparatus 270 for rolling the central portion 106 of the flexible glass ribbon 46 together with an interleaving material 272. The driven rollers 254b and 264 may be used for guiding the central portion 106 of the flexible glass ribbon 46 and driven rollers 280 may be used for guiding the interleaving material 272. The driven rollers 254b, 264, and 280 guide the flexible glass ribbon 46 and the interleaving material 272 to a roll 282, where they may be wound together. The free loop 262 may separate processing zone C from processing zone B and may compensate for differences (for example, as when rolling speed is varied at roll change over) in the flexible glass ribbon speeds between the upstream and rolling processes. In some embodiments, a surface protective film may be applied to one or both broad surfaces of the central portion 106 of the flexible glass ribbon 46.

As a moving body, the flexible glass ribbon can travel along a pre-defined direction aligned with the various processing apparatuses. The above-described methods and apparatuses for continuous manufacturing of flexible glass ribbon can be used to produce ultra-thin flexible glass spools. For example, the spools may include a ribbon having thicknesses ranging from about 50 microns to about 500 microns and ribbon widths ranging from about 1000 mm to about 3000 mm.

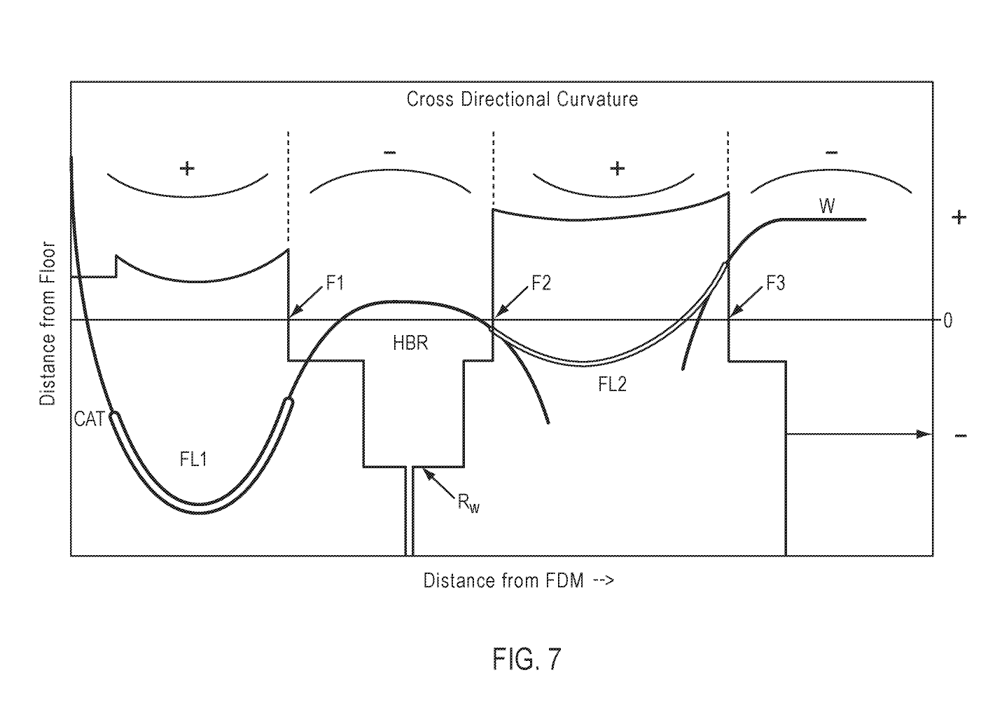

The above-described methods and apparatus for continuous manufacturing of flexible glass ribbon can provide ultra-thin flexible glass ribbon while maintaining a desired curvature profile of the flexible glass ribbon (e.g., minimizing curvature flips) in each of the processing and buffer zones. Referring to FIG. 7, a continuous process is depicted, as well as the MD and CD curvature changes at the different exemplary process stages. An exemplary process may include glass ribbon formation (e.g., in a first processing zone, not shown), catenary CAT, a first free loop FL1 (or first buffer zone), horizontal bead removal HBR (or second processing zone), a second free loop FL2 (or second buffer zone), and a winder W (or third processing zone). As can be appreciated from FIG. 7, the radius of MD curvature R_{W} of the flexible glass ribbon (or web) can change several times from positive (concave) to negative (convex) along the process, where an infinite radius (vertical line) indicates a substantially linear (not curved) orientation. For instance, the transition between FL1 and HBR in a traditional process can involve a first flip F1 in which the MD curvature of the ribbon switches from concave in FL1 to convex in HBR (e.g., the vertical line crosses the horizontal axis from positive to negative). A second transition from HBR to FL2 can involve a second flip F2 in which the MD curvature of the ribbon switches from convex in HBR to concave in FL2. Finally, upon transitioning into the winder, the ribbon may undergo a third flip F3, again from concave to convex.

It should be noted that radius of curvature is the inverse of curvature (R=1/C), and flips in curvature shape (e.g., convex to concave) also result in flips in radius of curvature (e.g., negative to positive). Flatter substrates are defined by a higher radius of curvature (e.g., when C is small, R is large) and a highly curved substrates are defined by a lower radius of curvature (e.g., when C is large, R is small). A completely flat substrate (C=0) has an infinite radius of curvature. Curved substrates that are convex relative to the horizontal plane have a negative radius of curvature, whereas concave substrates have a positive radius of curvature. As used herein, the term “positive” radius of curvature is intended to refer to glass ribbon with a non-zero and non-negative radius of curvature (e.g., excluding convex orientations).

As illustrated in the upper portion of FIG. 7, the CD curvature or bow of the ribbon can also flip from concave (+ radius of curvature) to convex (− radius of curvature) at transition points F1, F2, and/or F3. It should be noted that the CD curves in FIG. 7 provide a general depiction of the curvature shape with +/− used to indicate the general sign of the radius of curvature. The placement of these curves on the graph is not indicative of absolute radius of curvature values. The CD and MD curvatures can be perpendicular to each other, e.g., the CD curvature can be the curvature of the glass ribbon across its width, whereas the MD curvature can be the curvature of the glass ribbon along its length. As discussed above, one or both of the CD and MD curvatures of the glass ribbon can flip at various transitions between stages in the continuous process. The flips in CD curvature can correspond to flips in MD curvature, or can be independent of MD curvature, depending on the process design. The flips in MD and/or CD curvature can result in sheet vibration and/or motion, which can cause instability in the downstream process steps. In some embodiments, it may be desirable to minimize the number of flips in both MD and CD curvature to minimize process instabilities.

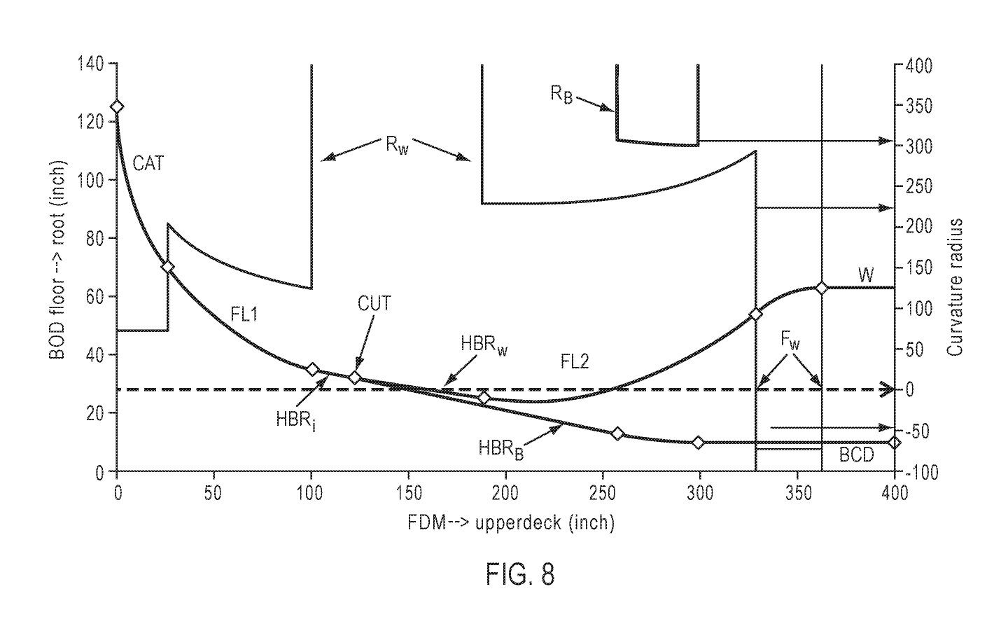

The methods and apparatuses disclosed herein can reduce or eliminate flips in MD and/or CD curvature and the instabilities associated therewith. For instance, referring to FIG. 8, a flip in MD curvature R_{W} can be avoided at the transition from the first free loop FL1 (e.g., first buffer zone) to the bead removal system HBR (e.g., second processing zone) such that there may be reduced vibration of the flexible glass ribbon, e.g., during scoring, cutting, and/or separation of the edge trim (or bead portions) from a central portion of the ribbon. This improvement in ribbon conveyance stability can result, in some embodiments, in a stable bead separation in the HBR, reduced downtime, improved cut quality, higher edge strength, and/or reduced particles around the separated edges. In additional embodiments, a flip in CD curvature can also be minimized or eliminated at this transition point (e.g., between the first buffer zone and the second processing zone).

Referring to FIG. 8, the processing path may pass through a first processing zone (not illustrated), in which the glass ribbon may be formed. From the bottom-of-draw (BOD), the flexible glass ribbon may then proceed through catenary CAT, which can bend the ribbon from vertical to a specified sweep angle. At the end of CAT, FL1 (or first buffer zone) can begin at the same or similar radius of curvature. An initial stage HBRᵢ of the HBR (or second processing zone) can follow FL1 and can comprise a linear downward slope, which can be drawn as a tangent to the bottom of FL1. After scoring and/or cutting the glass ribbon (CUT), the separated edge trim can follow bead track HBR_{B} to the bead cullet device BCD (the trim having a radius of curvature R_{B}), and the central portion of the ribbon can follow web path HBR_{W} through the HBR to FL2. In some embodiments, the path angle (e.g., angle of downslope relative to the horizontal axis of HBR) for the central portion (web path) HBR_{W} can be slightly smaller than that of the bead track HBR_{B}, such that the central portion is elevated with respect to the bead track and can proceed to FL2 while the bead portion can proceed to BCD. The curvature between HBR_{W} and FL2 can be maintained, for example, by height control.

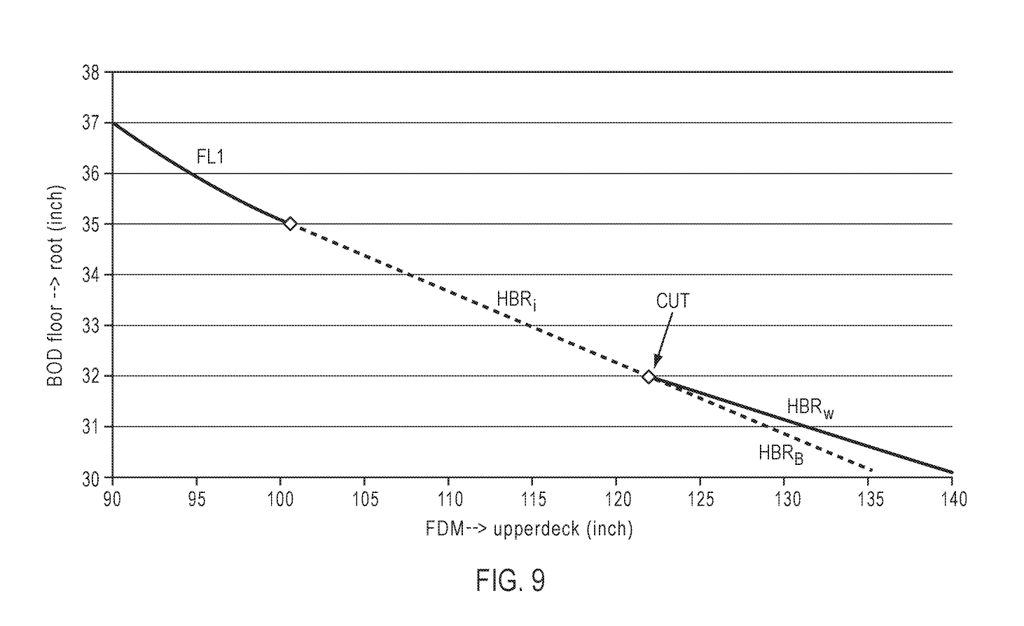

According to certain embodiments, a flip in MD curvature R_{W} can also be avoided at the transition from the first free loop HBR (e.g., second processing zone) to the second free loop FL2 (e.g., second buffer zone) such that there may be reduced stubbing, fracturing, and/or cracking out of the flexible glass ribbon. For instance, a large radius of curvature at the HBR inlet may allow for flattening of the cut table such that the product web HBR_{W} and/or the separated bead track HBR_{B} can avoid a curvature flip when transitioning to FL2 or the bead cullet device BCD, respectively. Further, as shown in FIG. 9, which is an enlarged view of the HBR portion of FIG. 8, the HBR can be sloped in a downward direction (e.g., inlet elevated above outlet) in a substantially linear fashion toward the bead cullet device BCD, which can allow for additional conveyance stability and may avoid potential stubbing issues. This improvement in ribbon conveyance can provide stability benefits for wider, thinner glass ribbons (e.g., thickness of about 0.5 mm or less). In additional embodiments, a flip in CD curvature can also be avoided at this transition point (e.g., between the second processing zone and the second buffer zone). The CD curvature may have a larger impact on downstream processing as the ribbon becomes thinner (e.g., thickness of about 0.3 mm, about 0.25 mm, or less).

In some embodiments, a concave or substantially linear MD curvature (e.g., positive or infinite radius of curvature) can be maintained from the first buffer zone (e.g., FL1) through the second processing zone (e.g., HBR), and to the second buffer zone (e.g., FL2), as indicated by the curve R_{W}, which is positive (concave) or infinite (flat) through these zones. According to additional embodiments, the CD curvature can also be concave or substantially linear through these zones. In further embodiments, the MD and/or CD curvature of the flexible glass ribbon may flip F_{W} one or more times (e.g., to convex and/or back to concave) upon entry to the third processing stage, e.g., at position(s) F_{W}, such as the upper deck of winder W. Until position(s) F_{W}, the flexible glass ribbon can be maintained in a concave and/or substantially linear MD and/or CD curvature, e.g., avoiding any flips to a convex curvature.

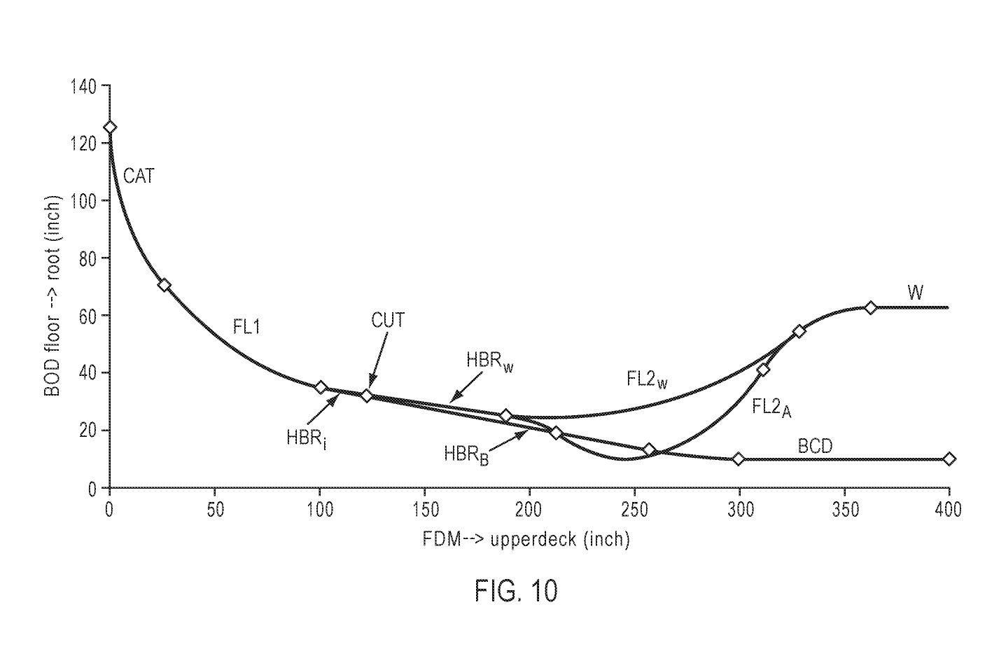

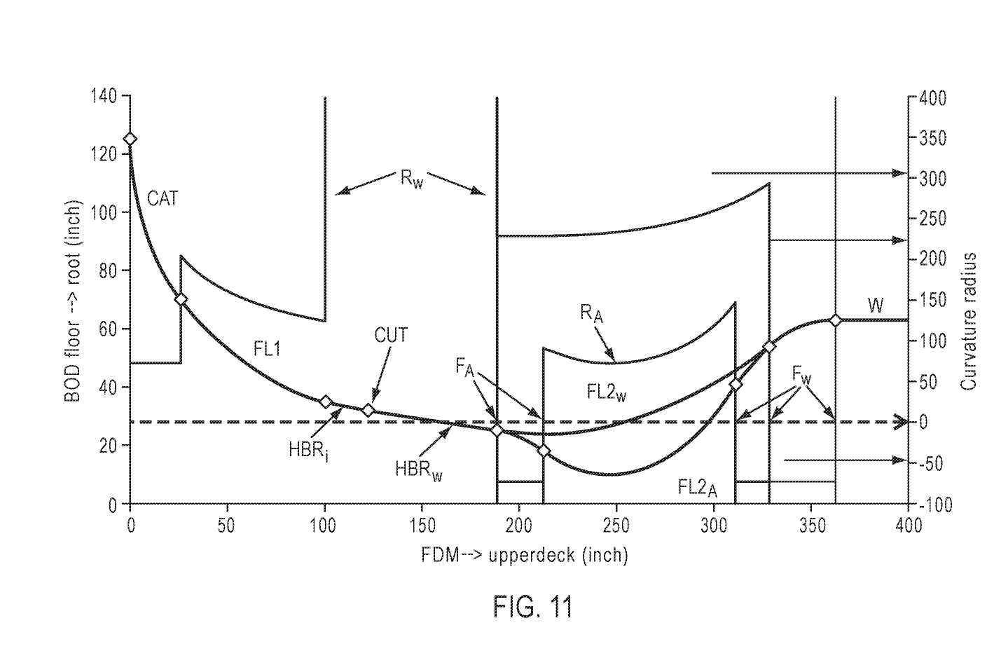

As shown in FIG. 10, the continuous processing method can also include web accumulation in one or both of the free loops FL1 and/or FL2 (FL2 shown). Accumulation in the free loops can be provided, for example, by including upward curvature supports (e.g., “turtlebacks” or rollers) at both ends of the loop. However, as shown in FIG. 11, accumulation in the loop FL2_{A} may result in one or more flips F_{A} in curvature R_{A} as compared to the curvature R_{W} non-accumulated loop FL2_{W}.

The methods and apparatuses described herein, including the web paths schematically illustrated in FIGS. 8-11 may, in some embodiments, include the following assumptions between connected processing or buffering zones: (a) freedom from local bending, e.g., two adjacent zones may be tangent to the same curve; and (b) the sign of curvature for any curves is positive (concave) or infinite (flat). The geometrical constraints and stress limits of a given process may be satisfied by adjusting one or more of the following variables: (V1) height of winder W upper deck, (V2) radius of upper deck curvature support (“turtleback”), (V3) minimum radius of curvature of FL2, (V4) height of the bottom of FL2, (V5) height of HBR outlet, (V6) radius of HBR outlet curvature support, (V7) height of cutting region within HBR, (V8) slope angle for HBR_{W}, (V9) height of HBR inlet, (V10) slope angle of HBRᵢ, (V11) minimum radius of curvature of FL1, (V12) CAT sweep angle, (V13) radius of curvature of CAT, (V14) height of BCD, and (V15) design of HBR_{B}. By adjusting variables (V1)-(V15), various web paths can be formulated to accommodate the geometrical and/or other constraints of a given processing system.

According to non-limiting embodiments, a glass processing apparatus can be configured by spatially positioning one or more zones with respect to each other such that a concave or substantially linear MD and/or CD curvature of the flexible glass ribbon is maintained through at least a portion of the process. For instance, the first buffer zone, second processing zone, and second buffer zone can be positioned relative to each other such that a concave or substantially linear MD and/or CD curvature of the flexible glass ribbon is maintained through all or a portion of these zones, including the transitions between zones.

For example, in some embodiments, the first buffer zone can be configured such that a first upstream (inlet) position in the first pair of spaced-apart payoff positions is elevated relative to a first downstream (outlet) position in the first pair of spaced-apart payoff positions. In further embodiments, the first buffer zone and the second processing zone can be positioned with respect to each other such that the first downstream (outlet) position in the first buffer zone is elevated relative to an edge trimming position (CUT) in the second processing zone. According to additional embodiments, the second processing zone can be configured such that the edge trimming position is elevated relative to an outlet of the second processing zone. In certain embodiments, the second buffer zone and second processing zone can be positioned with respect to each other such that a second downstream (outlet) position in the second pair of spaced-apart payoff positions is elevated relative to the outlet of the second processing zone. According to still further embodiments, the second buffer zone can be configured such that a second downstream (outlet) position in the second pair of spaced-apart payoff positions is elevated relative to a second upstream (inlet) position in the second pair of spaced-apart payoff positions.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “at least one sensor” includes examples having two or more such sensors unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device that comprises A+B+C include embodiments where a device consists of A+B+C and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A method of continuous processing of a flexible glass ribbon having a thickness of no more than 0.5 mm, the method comprising:
continuously feeding the flexible glass ribbon from a first processing zone, through a second processing zone and to a third processing zone of a glass processing apparatus;
supporting the flexible glass ribbon in a first catenary between a first pair of spaced-apart payoff positions in a first buffer zone located between the first processing zone and the second processing zone;
supporting the flexible glass ribbon in a second catenary between a second pair of spaced-apart payoff positions in a second buffer zone located between the second processing zone and the third processing zone; and
maintaining a positive or infinite machine directional radius of curvature of the flexible glass ribbon during transition from at least one of (a) the first buffer zone to the second processing zone or (b) the second processing zone to the second buffer zone.

2. The method of claim 1, wherein the machine directional radius of curvature is positive in the first and second buffer zones and infinite in the second processing zone.

3. The method of claim 1, further comprising maintaining a positive cross-directional radius of curvature of the flexible glass ribbon during transition from at least one of (a) the first buffer zone to the second processing zone or (b) the second processing zone to the second buffer zone.

4. The method of claim 1, wherein a cross-directional radius of curvature of the flexible glass ribbon is positive or infinite in the first buffer zone, second processing zone, or second buffer zone.

5. The method of claim 1, comprising producing the flexible glass ribbon in the first processing zone using a forming apparatus.

6. The method of claim 5, wherein the step of producing the flexible glass ribbon includes using a fusion draw process.

7. The method of claim 1, wherein the first pair of spaced-apart payoff positions comprises a first upstream position and a first downstream position, the first upstream position being elevated relative to the first downstream position.

8. The method of claim 1, further comprising maintaining the flexible glass ribbon in a substantially linear orientation in the second processing zone.

9. The method of claim 1, comprising processing an edge of the flexible glass ribbon as the flexible glass ribbon moves by a cutting device within the second processing zone to form a continuous strip of edge trim connected to a central portion of the flexible glass ribbon.

10. The method of claim 9, wherein the second processing zone comprises a bead removal system for separating the continuous strip of edge trim from the central portion of the flexible glass ribbon.

11. The method of claim 1, wherein an inlet of the second processing zone is elevated relative to an outlet of the second processing zone.

12. The method of claim 1, wherein the second pair of spaced-apart payoff positions comprises a second upstream position and a second downstream position, the second downstream position being elevated relative to the second upstream position.

13. The method of claim 1, wherein a feed rate of the flexible glass ribbon through at least one of the first, second, or third processing zones is controlled using a global control device.

14. The method of claim 13, wherein the first and second pairs of spaced-apart payoff positions comprise rollers, and wherein rotation of at least one of the rollers is controlled by the global control device.

15. The method of claim 1, comprising winding the flexible glass ribbon into a roll in the third processing zone using a winding apparatus.

16. A method of continuous processing of a flexible glass ribbon having a thickness of no more than 0.5 mm using a glass processing apparatus including a forming apparatus in a first processing zone, an edge trimming apparatus in a second processing zone, and a winding apparatus in a third processing zone, the method comprising:
forming the flexible glass ribbon in the first processing zone and feeding the flexible glass ribbon though the first processing zone;
feeding the flexible glass ribbon through the second processing zone while separating a continuous strip of edge trim from a central portion of the flexible glass ribbon; and
feeding the flexible glass ribbon through the third processing zone while winding the flexible glass ribbon into a roll;
wherein a positive machine directional radius of curvature of the flexible glass ribbon is maintained within a first buffer zone between the first and second processing zones and within a second buffer zone between the second and third processing zones; and
wherein an infinite machine directional radius of curvature of the flexible glass ribbon is maintained within the second processing zone.

17. An apparatus for processing a flexible glass ribbon having a thickness of no more than 0.5 mm, the apparatus comprising:
a forming apparatus in a first processing zone, the forming apparatus configured to form a flexible glass ribbon;
an edge trimming apparatus in a second processing zone, the edge trimming apparatus configured to separate a continuous strip of edge trim from a central portion of the flexible glass ribbon;
a winding apparatus in a third processing zone, the winding apparatus configured to wind the flexible glass ribbon into a roll;
a first buffer zone between the first processing zone and the second processing zone in which the flexible glass ribbon is supported in a first catenary between a first upstream payoff position and a first downstream payoff position; and
a second buffer zone between the second processing zone and the third processing zone in which the flexible glass substrate is supported in a second catenary between a second upstream payoff position and a second downstream payoff position,
wherein the first upstream payoff position is elevated relative to an edge trimming position in the second processing zone, the edge trimming position is elevated relative to a second processing zone outlet, and the second downstream payoff position is elevated relative to the second processing zone outlet.

18. The apparatus of claim 17, wherein the first processing zone, first buffer zone, second processing zone, and second buffer zone are positioned relative to each other such that a positive or infinite machine directional radius of curvature of the flexible glass ribbon is maintained during transition from at least one of (a) the first buffer zone to the second processing zone or (b) the second processing zone to the second buffer zone.

19. The apparatus of claim 17, wherein the second processing zone is positioned at a downslope and the flexible glass ribbon is maintained in a substantially linear orientation in the second processing zone.

20. The apparatus of claim 17, wherein the forming apparatus is a fusion draw machine.

21. The apparatus of claim 17, wherein the first upstream payoff position is elevated relative to the first downstream payoff position, and the second downstream payoff position is elevated relative to the second upstream payoff position.
